(19) United States
(12) Patent Application Publication
(10) Pub. No.: US 2021/0188290 A1
(43) Pub. Date: Jun. 24, 2021

(54) DRIVING MODEL TRAINING METHOD, DRIVER IDENTIFICATION METHOD, APPARATUSES, DEVICE AND MEDIUM

(71) Applicant: Ping An Technology (Shenzhen) Co., Ltd., Shenzhen (CN)

(72) Inventors: Xin JIN, SHENZHEN (CN); Zhuangwei WU, SHENZHEN (CN); Chuan ZHANG, SHENZHEN (CN); Yuanyuan ZHAO, SHENZHEN (CN); Duxin HUANG, SHENZHEN (CN); Yongjian LIANG, SHENZHEN (CN); Li HUO, SHENZHEN (CN)

(21) Appl. No.: 16/093,633

(22) PCT Filed: Oct. 31, 2017
(86) PCT No.: PCT/CN2017/108517

§ 371 Date: Oct. 13, 2018

(30) Foreign Application Priority Data
Sep. 19, 2017 (CN) 201710846499.1

(51) Int. Cl. B60W 40/09; G06K 9/62; G06N 3/08

(52) U.S. Cl. CPC B60W 40/09; G06K 9/6256; G06K 9/6272; B60W 2040/0809; G06K 9/6288; G06N 3/084; G06K 9/6218

(57) ABSTRACT

A driving model training method, a driver identification method, apparatuses, a device and a medium are provided. The driving model training method comprises: acquiring training behavior data of a user wherein the training behavior data are associated with a user identifier; acquiring training driving data associated with the user identifier based on the training behavior data; acquiring positive and negative samples from the training driving data based on the user identifier, and dividing the positive and negative samples into a training set and a test set; training the training set using a bagging algorithm, and acquiring an original driving model; and testing the original driving model using the test set, and acquiring a target driving model. The driving model training method effectively enhances generalization of the driving model, solves the problem of a poor identification result of the current driving identification model.

This application claims priority to Chinese Patent Application No. 201710846499.1 with a filing date of Sep. 19, 2017, entitled “driving model training method, driver identification method, apparatuses, device and a medium”.

### TECHNICAL FIELD

The present disclosure relates to the field of behavior identification, and more particularly to a driving model training method, a driver identification method, apparatuses, a device and a medium.

### BACKGROUND OF THE PRESENT INVENTION

With development of the information age, the artificial intelligence technology, as a core technology, is increasingly used for solving specific problems in human life. Currently, when judging whether a mobile phone user drives, a single model is generally adopted to identify a driver, to confirm whether the mobile phone user drives. This way of only using the single model to identify the driver has limitations. Meanwhile, such single model has relatively poor generalization ability, causing that the acquired identification result could not well reflect whether the mobile phone user drives. Namely, the identification result is poor, causing that the accuracy of identifying whether the mobile phone user drives currently is low.

### SUMMARY OF PRESENT INVENTION

Embodiments of the present disclosure provide a driving model training method, a driver identification method, apparatuses, a device and a medium, to solve the problem of poor identification effect of the driving model in prior art.

In a first aspect, embodiments of the present disclosure provide a driving model training method, comprising: acquiring training behavior data of a user wherein the training behavior data are associated with a user identifier; acquiring training driving data associated with the user identifier based on the training behavior data; acquiring positive and negative samples from the training driving data based on the user identifier, and dividing the positive and negative samples into a training set and a test set; training the training set using a bagging algorithm, and acquiring an original driving model; and testing the original driving model using the test set, and acquiring a target driving model.

In a second aspect, embodiments of the present disclosure provide a driving model training apparatus, comprising: a training behavior data acquisition module, configured to acquire training behavior data of a user wherein the training behavior data are associated with a user identifier, a training driving data acquisition module, configured to acquire training driving data associated with the user identifier based on the training behavior data; a positive and negative samples acquisition module, configured to acquire positive and negative samples from the training driving data based on the user identifier, and divide the positive and negative samples into a training set and a test set; an original driving model acquisition module, configured to train the training set using a bagging algorithm, and acquire an original driving model; and a target driving model acquisition module, configured to test the original driving model using the test set, and acquire a target driving model.

In a third aspect, embodiments of the present disclosure provide a driver identification method, comprising: acquiring to-be-identified behavior data of a user wherein the to-be-identified behavior data are associated with a user identifier; querying a database based on the user identifier, and acquiring a target driving model corresponding to the user identifier; acquiring an identification probability based on the to-be-identified behavior data and the target driving model; and judging whether the identification probability is greater than a preset probability, and determining that a driver herself/himself drives if the identification probability is greater than the preset probability.

In a fourth aspect, embodiments of the present disclosure provide a driver identification apparatus, comprising: a to-be-identified behavior data acquisition module, configured to acquire to-be-identified behavior data of a user wherein the to-be-identified behavior data are associated with a user identifier; a target driving model acquisition module, configured to query a database based on the user identifier, and acquire a target driving model corresponding to the user identifier; an identification probability acquisition module, configured to acquire an identification probability based on the to-be-identified behavior data and the target driving model; and an identification result judgment module, configured to judge whether the identification probability is greater than a preset probability, and determine that a driver herself/himself drives if the identification probability is greater than the preset probability.

Ina fifth aspect, embodiments of the present disclosure provide a terminal device, comprising a memory, a processor and a computer readable instruction stored in the memory and operated on the processor. The following steps are achieved when the processor executes the computer readable instruction: acquiring training behavior data of a user wherein the training behavior data are associated with a user identifier; acquiring training driving data associated with the user identifier based on the training behavior data; acquiring positive and negative samples from the training driving data based on the user identifier, and dividing the positive and negative samples into a training set and a test set; training the training set using a bagging algorithm, and acquiring an original driving model; and testing the original driving model using the test set, and acquiring a target driving model.

Ina sixth aspect, embodiments of the present disclosure provide a terminal device, comprising a memory, a processor and a computer readable instruction stored in the memory and operated on the processor. The following steps are achieved when the processor executes the computer readable instruction: acquiring to-be-identified behavior data of a user wherein the to-be-identified behavior data are associated with a user identifier, querying a database based on the user identifier, and acquiring a target driving model corresponding to the user identifier; acquiring an identification probability based on the to-be-identified behavior data and the target driving model; and judging whether the identification probability is greater than a preset probability, and determining that a driver herself/himself drives if the identification probability is greater than the preset probability.

In a seventh aspect, embodiments of the present disclosure provide a computer readable medium which stores the compute readable instruction. The following steps are achieved when the processor executes the computer readable instruction: acquiring training behavior data of a user wherein the training behavior data are associated with a user identifier; acquiring training driving data associated with the user identifier based on the training behavior data; acquiring positive and negative samples from the training driving data based on the user identifier, and dividing the positive and negative samples into a training set and a test set; training the training set using a bagging algorithm, and acquiring an original driving model; and testing the original driving model using the test set, and acquiring a target driving model.

In an eighth aspect, embodiments of the present disclosure provide a computer readable medium which stores the compute readable instruction. The following steps are achieved when the processor executes the computer readable instruction: acquiring to-be-identified behavior data of a user wherein the to-be-identified behavior data are associated with a user identifier; querying a database based on the user identifier, and acquiring a target driving model corresponding to the user identifier, acquiring an identification probability based on the to-be-identified behavior data and the target driving model; and judging whether the identification probability is greater than a preset probability, and determining that a driver herself/himself drives if the identification probability is greater than the preset probability.

In the driving model training method and apparatus, the terminal device and a storage medium provided by embodiments of the present disclosure, the training behavior data of the user is firstly acquired, and is associated with the user identifier, such that training behavior data corresponding to a target user identifier and a non-target user identifier is respectively acquired based on the user identifier, to guarantee that a target driving model obtained through training could identify a driving behavior of a target user. Then, the training driving data associated with the user identifier is acquired based on the training behavior data. The training driving data is training behavior data extracted from different behavior types and corresponding to a driving type, and interference of other non-driving behavior data is eliminated, thereby being conducive to guaranteeing the identification accuracy rate of the target driving model obtained through training and improving the training efficiency of the target driving model, and saving the training time. Next, the positive and negative samples are obtained from the training driving data based on the user identifier, and could effectively determine the parameters required by a training target driving model, thereby guaranteeing the accuracy of an identification result of the target driving model obtained through training. Finally, the training set is trained using the bagging algorithm, and the original driving model is acquired and tested to acquire the target driving model, thereby enhancing the generalization of the target driving model, and improving the identification accuracy rate of the target driving model.

In the driver identification method and apparatus, the terminal device and the storage medium provided by embodiments of the present disclosure, the to-be-identified behavior data and the target driving model are obtained, and the identification probability is acquired based on the to-be-identified behavior data and the target driving model. It determines whether the driver herself/himself drives by judging whether the identification probability is greater than the preset probability, so that the driver identification result is more accurate and reliable.

### DESCRIPTION OF THE DRAWINGS

In order to make the technical solutions in the disclosure or in the prior art described more clearly, the drawings associated to the description of the embodiments or the prior art will be illustrated concisely hereinafter. Obviously, the drawings described below are only some embodiments according to the disclosure. Numerous drawings therein will be apparent to one of ordinary skill in the art based on the drawings described in the disclosure without creative efforts.

FIG. 1 is a flowchart of a driving model training method provided in Embodiment 1 of the present disclosure;

FIG. 2 is a specific flow chart of step S12 in FIG. 1;

FIG. 3 is a specific flow chart of step S121 in FIG. 2;

FIG. 4 is a specific flow chart of step S13 in FIG. 1;

FIG. 5 is a specific flow chart of step S14 in FIG. 1;

FIG. 6 is a principle block diagram of a driving model training apparatus in Embodiment 2 of the present disclosure;

FIG. 7 is a flowchart of a driver identification method in Embodiment 3 of the present disclosure;

FIG. 8 is a principle block diagram of a driver identification apparatus in Embodiment 4 of the present disclosure; and

FIG. 9 is a schematic diagram of a terminal device provided in Embodiment 6 of the present disclosure.

### DETAILED DESCRIPTION OF PREFERRED EMBODIMENTS

In order to make the objects, technical solution and advantages of the present disclosure more clear, the present disclosure will be further described in detail with reference to the accompanying drawings and embodiments below. It should be understood that embodiments described here are only for explaining the present disclosure and the disclosure, however, should not be constructed as limited to the embodiment as set forth herein.

### Embodiment 1

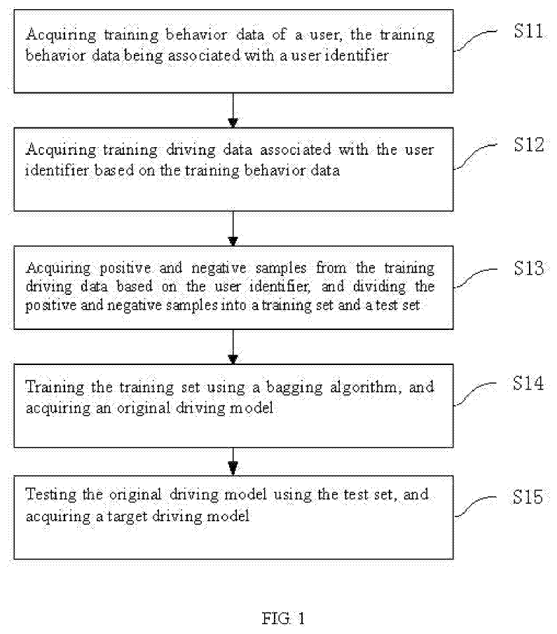

FIG. 1 is a flow chart of a driving model training method provided in the present embodiment. The driving model training method may be applied in a terminal device of an insurance institution or other institutions, and used for training a driving model, so as to identify with the trained driving model, thereby achieving an intelligent identification effect. For example, the driving model training method could be applied in the terminal device of the insurance institutions, and used for training a driving model corresponding to a user, so as to identify a user handling a vehicle insurance in the insurance institution by using the trained driving mode, and determine whether the user drives. As shown in FIG. 1, the driving model training method comprises the following steps:

S11: acquiring training behavior data of a user wherein the training behavior data are associated with a user identifier.

The training behavior data refers to behavior data acquired when traveling and used for training the driving mode. The behavior data includes, but not limited to, at least one of a speed, an acceleration, an angle, an angular acceleration and other data collected by the user at any time when travelling. The user identifier is an identifier for uniquely identifying the user, and is configured to guarantee the driving model obtained through training can be used for identifying whether the user drives. All the acquired training behavior data should be associated with the user identifier. The training behavior data is associated with the user identifier, and refers to the training behavior data generated by each user corresponding to the user identifier when traveling. It could be understood that, one user identifier could be associated with multiple training behavior data.

In the present embodiment, the user completes registration in an disclosure (APP for short) on a mobile phone, a tablet PC and other mobile terminals, so that a server corresponding to the APP could acquire the corresponding user identifier. The user identifier may be mobile phone numbers or an ID card number of the user or other identifiers capable of uniquely identifying the user. When the user travels by carrying the mobile terminal, a sensor installed in the mobile terminal can collect the speed, the acceleration, the angle, the angular acceleration and other behavior data of the user at any time in a traveling process in real time, can also collect GPS positioning information at any time in real time, and can calculate based on the GPS positioning information to acquire the corresponding behavior data. After the mobile terminal acquires the behavior data, the behavior data is uploaded to the server, so that the server stores the acquired behavior data into a database, such as MySQL and Oracle, and each behavior data and a user identifier are subjected to associative storage. When the terminal device needs to train the driving model, the behavior data associated with the user identifier could be queried from the database, such as MySQL and Oracle, and acquired, and used as the training behavior data for training the driving model. A lot of training behavior data is stored in the database, which provides a good data base for training the driving model, to guarantee the identification effect of the driving model obtained through training.

The current user could travel with at least one traffic mode of walk, a bicycle, a light motorcycle, a bus, a saloon car, a railway and an aircraft when traveling, and the speeds, the accelerations, the angles, the angular accelerations and other behavior data corresponding to the different traffic modes are different. Therefore, the training behavior data acquired in step S11 may be the behavior data corresponding to the walk, the bicycle, the railway, the aircraft and other traffic modes, which has a big difference with the behavior data when the user drives a vehicle. If the driving model is trained directly based on the training behavior data acquired in step S11, the identification effect of the driving model obtained through training may be affected.

S12: acquiring training driving data associated with the user identifier based on the training behavior data.

The training driving data refers to the behavior data acquired by the user when traveling in the traffic mode of driving the saloon car and used for training the driving mode. It could be understood that, since each training behavior data is associated with the user identifier, and the training driving data is one of the training behavior data, the training driving data is associated with the user identifier. The training driving data is distinguished from the behavior data collected in the training behavior data when traveling by the walk, the bicycle, the railway and the aircraft, rather than the saloon car, and the training driving data is acquired from the training behavior data, and is beneficial to guaranteeing that the driving model obtained by training could better reflect a driving habit of the user, so as to identify whether the user drives. In the present embodiment, the training behavior data acquired originally could not be directly used for training the driving model. Therefore, the behavior data collected by the user when traveling by driving the saloon car should be extracted from the training behavior data as the training driving data of the driving model. The mobile terminal collects the training behavior data of the user and stores the training behavior data into the database, and identifies and extracts the training driving data corresponding to the user driving behavior data in the behavior data from all kinds of training behavior data, so that the acquired training driving data could be applied in a training process of the driving model, thereby providing reliable training driving data for the training process of the driving model.

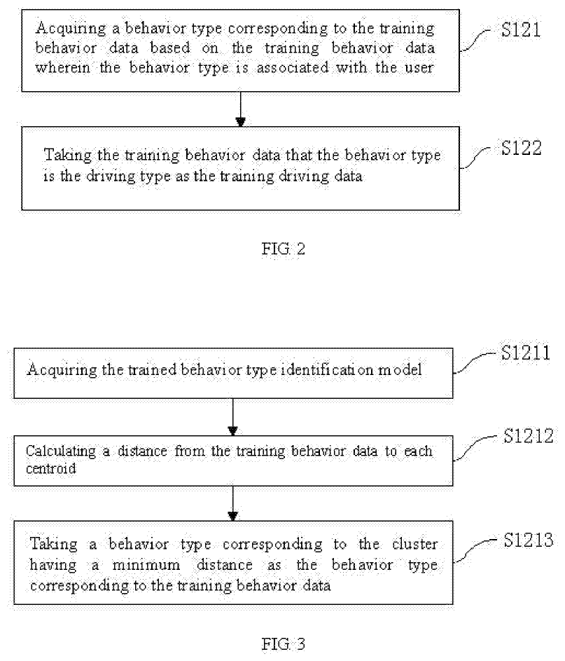

As shown in FIG. 2, in step S12, the step of acquiring the training behavior data of the user and associating the training behavior data with the user identifier in step S12 specifically includes the following steps:

S121: acquiring a behavior type corresponding to the training behavior data based on the training behavior data wherein the behavior type is associated with the user identifier.

The behavior type is a user travel traffic mode corresponding to the training behavior data. The user could travel by the walk, the bicycle, the light motorcycle, the bus, the saloon car, the railway, the aircraft and other traffic modes. The training behavior data could include the speed, the acceleration, the angle, the angular acceleration and other behavior data. In the present embodiment, each behavior type is associated with the corresponding user identifier. The APP on the mobile terminal identifies the behavior types corresponding to different training behavior data in the training behavior data according to the acquired training behavior data, and acquires the behavior type associated with the user identifier.

Specifically, a user A and a user B could adopt the mobile terminal to upload the behavior data to the server, so that the terminal device, when conducting the driving model training, could acquire the speed, the acceleration, the angle, the angular acceleration and other training behavior data corresponding to multiple times of the user A and acquires the speed, the acceleration, the angle, the angular acceleration and other training behavior data corresponding to multiple times of the user B from the database through the server, determines that the acquired training behavior data belongs to the user A or the user B according to the user identifier, processes the training behavior data, such as speed, the acceleration, the angle, the angular acceleration and other behavior data, and identifies that the behavior type corresponding to the training behavior data of the user belongs to the walking, the bicycle, the light motorcycle, the bus, the saloon car, the railway, the aircraft or other traffic modes, to acquire the behavior type corresponding to the training behavior data.

As shown in FIG. 3, in step S121, the step of acquiring the behavior type corresponding to the training behavior data based on the training behavior data and associating the behavior type with the user identifier specifically includes the following steps:

S1211: acquiring the trained behavior type identification model which includes at least two clusters, each of the clusters corresponding to a behavior type and including a centroid.

The behavior type identification model is a pre-trained model for identifying the behavior type corresponding to the behavior data. The behavior type identification model is pre-stored in the database, and when the terminal device conducts the driving model training, the behavior type identification model could be invoked from the database. In the present embodiment, the behavior type identification model is a model acquired after clustering processing is conducted on historical behavior data through a K-means clustering algorithm. The historical behavior data is the behavior data acquired by the user when traveling and used for training the behavior type identification mode. The behavior data includes but not limited to at least one of the speed, the acceleration, the angle, the angular acceleration and other data collected by the user when traveling at any time. The K-means clustering algorithm is a clustering algorithm based on a distance evaluation similarity, i.e., a clustering algorithm that the closer the distance of the two objects is, the higher the similarity is.

Specifically, the behavior type identification model acquired after clustering with the K-means clustering algorithm includes at least two clusters. Each of the clusters corresponds to a behavior data and includes a centroid. In the present embodiment, the trained behavior type identification model may include seven clusters, each of which respectively represents the walking, the bicycle, the light motorcycle, the bus, the saloon car, the railway and the aircraft, i.e., each cluster represents a behavior type. If the distance from the training behavior data to the centroid of the cluster is smaller, the training behavior data more possibly belongs to the behavior type corresponding to the cluster.

S1212: calculating a distance from the training behavior data to each centroid.

In the present embodiment, a distance between the acquired training behavior data and the centroid corresponding to the at least two clusters is respectively calculated, to determine the similarity between the training behavior data and each cluster. The similarity between the training behavior data and each cluster is evaluated according to a size of a Euclidean distance by calculating the Euclidean distance between the training behavior data and the centroid corresponding to each cluster. The Euclidean distance (also called as Euclidean metric) refers to a true distance between two points in an m-dimensional space, or a natural length of a vector (i.e. a distance from this point to an original point). The Euclidean distance of any two n-dimensional vectors a (Xᵢ₁, Xᵢ₂, . . . , Xᵢₙ) and b(Xⱼ₁, Xⱼ₂, . . . , Xⱼₙ) is

$${D}_{a , b} = \sqrt{{\sum }_{k = 1}^{n} {( {X}_{tk} - {X}_{jk} )}^{2}} .$$

S1213: taking a behavior type corresponding to the cluster having a minimum distance as the behavior type corresponding to the training behavior data.

In the present embodiment, the behavior type corresponding to the cluster to which the centroid having the minimum distance belongs and obtained through the calculation is taken as the behavior type corresponding to the training behavior data by calculating the Euclidean distance between the training behavior data and the centroid corresponding to each cluster. It could be understood that, the closer the distance between the training behavior data and the behavior type corresponding to the cluster is, the more possible the training behavior data belongs to the behavior type represented by the cluster. For example, when the acquired speed of the user A acquired is 40 km/s, the acceleration is 5 km/s², and the behavior type identification model includes seven clusters, then the Euclidean distances between the training behavior data and the centroids of the seven clusters are calculated respectively; and then, the sizes of the seven Euclidean distances acquired through calculation are compared, and the behavior type corresponding to the cluster to which the centroid having the minimum Euclidean distance belongs is determined as the behavior type corresponding to the training behavior data.

S122: taking the training behavior data that the behavior type is the driving type as the training driving data.

The driving type refers to one of the behavior types corresponding to the user identifier, and specifically refers to the behavior type of the user to select the driving way when travelling. In the present embodiment, the terminal device identifies the behavior type corresponding to the training behavior type, and then selects the training behavior data that the behavior type is the driving type as the training driving data, so as to train the driving model for identifying whether the user drives by means of the training driving data. Specifically, the terminal device acquires the behavior types (such as the walking, the bus, the saloon car and the aircraft) possibly corresponding to the training behavior data of the user A from the database, determines each behavior type corresponding to the training behavior data when identifying the training behavior data according to step S121, and then selects the training behavior data that the behavior type is the driving type as the training driving data. The training driving data required for the training of the driving model could be acquired by selecting the driving behavior type from a plurality of behavior types, thereby contributing to improvement of the accuracy rate that the trained driving model identifies whether the user drives.

S13: acquiring positive and negative samples from the training driving data based on the user identifier, and dividing the positive and negative samples into a training set and a test set.

Specifically, the user identifier refers to an identifier for determining a user identity. The positive sample refers to the to-be-identified training driving data of driving of the user, and the negative sample refers to the training driving data, not required for identification, of driving of the user. In the present embodiment, the training driving data is extracted from the training behavior data, and the training behavior data is associated with the user identifier. Therefore, the training driving data is also associated with the user identifier. According to the user identifier of the training driving data, the positive and negative samples for the driving model training could be acquired simply and quickly.

The training set is a learning sample data set, and refers to building a classifier by matching some parameters, i.e., training a machine learning model using the positive and negative samples in the training set, to determine parameters of the machine learning model. The test set is used for testing a resolution capability (such as an identification rate or the accuracy rate) of the trained machine learning model. For example, the positive and negative samples may be classified according to a ratio of 9:1, namely, 90% of positive and negative samples are taken as the training set, and the remaining 10% of data is taken as the test set. Since the behavior type of the user is related to a macroscopic road condition, and the driving behaviors are similar and are undistinguishable in most of the time during travel, the training duration of the driving data should be shortened, so that the obtained training driving data is more representative, is highly distinguishable, and is beneficial to saving the training duration of the driving model. In the present embodiment, step S13 specifically includes: selecting data of a preset data duration from the training driving data as the positive and negative samples based on the user identifier, to achieve the purpose of shortening the training duration of the driving data, so as to shorten the training duration of the driving model. The preset data duration is a duration preset by a system and used for defining data collection. If data acquired within 10 min from the beginning of each travel is collected from the training driving data as the positive and negative samples, the positive and negative samples could be the training driving data collected when the user just drives the saloon car to leave a neighborhood or just leaves an underground parking garage. The required parameters in the driving model could be effectively trained through the positive and negative samples acquired through the training driving data, so as to effectively prevent a situation that a training result tends to be extreme, so that the identification effect of the driving model obtained through training with the positive and negative samples is more accurate.

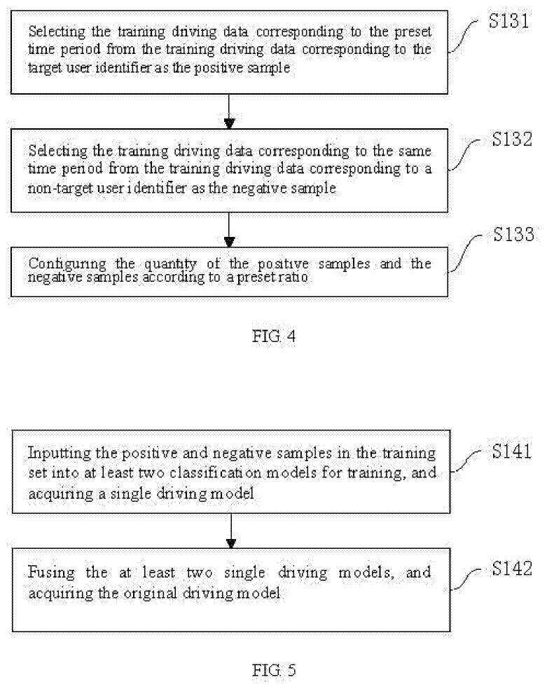

As shown in FIG. 4, in step S13, the step of acquiring the positive and negative samples from the training driving data based on the user identifier specifically includes the following steps:

S131: selecting the training driving data corresponding to the preset time period from the training driving data corresponding to the target user identifier as the positive sample.

A target user means a user to be identified by the driving model. Correspondingly, the target user identifier is an identifier for uniquely identifying the target user. In the present embodiment, the training driving data corresponding to the target user identifier is selected, and the training driving data corresponding to the preset time period is taken as the positive sample. Specifically, the positive sample could be training driving data of the target user A in the training driving data in the first 600 s (namely, the preset data duration) of the preset time period, such as 8-9 a.m. of two consecutive months. In order to further save the training duration of the driving model, the training driving data corresponding to the positive sample could be data acquired at every unit time of the preset data duration. If any training driving data is acquired every 10 s in the first 600 s once, 60 specific training driving data could be acquired as the positive samples.

S132: selecting the training driving data corresponding to the same time period as the preset time period from the training driving data corresponding to a non-target user identifier as the negative sample.

A non-target user means other users beyond the user to be identified by the driving model. Correspondingly, the non-target user identifier is an identifier for uniquely identifying the non-target user. In the present embodiment, the training driving data corresponding to the non-target user identifier is selected, and the training driving data corresponding to the preset time period is taken as the negative sample. It could be understood that, the preset time period corresponding to the training driving data, selected from the negative sample, is the same as the preset time period corresponding to the training driving data, selected from the positive sample, to guarantee that the negative sample and the positive sample are the training driving data acquired by different users under the same condition. Specifically, the negative sample may be the training driving data of a non-target user B or a non-target user C in the training driving data in the first 600 s of the preset time period, such as 8-9 a.m. of two consecutive months. In order to further save the training duration of the driving model, the training driving data corresponding to the negative sample could be data acquired at every unit time of the preset data duration, and the unit time is the same as the unit time of the positive sample. If any training driving data is acquired every 10 s in the first 600 s once, 60 specific training driving data could be acquired as the negative samples.

Further, to improve the training accuracy of the driving model, when the driving model corresponding to the target user is trained, the terminal device could also receive a data query instruction inputted by the user, and the data query instruction includes the target user identifier. The terminal device queries detailed target user information corresponding to the target user identifier through a database query statement after receiving the data query instruction. The detailed target user information includes a home address, an office address, office hours and other information of the target user. Moreover, the terminal device further queries whether the non-target user having the same or similar detailed target user information exists in the database, so that the terminal device could query based on the non-target user identifier corresponding to the non-target user and acquire the corresponding training driving data as the negative sample. Thus, the detailed information of the positive and negative samples is the same or similar, and the macroscopic road conditions of the collected training driving data corresponding to the target user and the non-target user are basically similar, thereby being more beneficial to guaranteeing the identification accuracy rate of the driving model obtained through training when the driving model is trained.

S133: configuring quantities of the positive samples and the negative samples according to a preset ratio.

The preset ratio refers to an initial preset quantity ratio of the positive samples to the negative samples. In the present embodiment, the positive and negative samples are mixed with a ratio of 1:1, so as to avoid an overfitting phenomenon due to the difference of the quantities of the training driving data corresponding to the positive and negative samples, wherein overfitting is a phenomenon that enables a hypothesis to become too strict in order to get a consistent hypothesis. Avoidance of overfitting is a core task in the design of the classifier. Specifically, 60 specific training driving data could be taken as the positive samples and 60 specific training driving data could be taken as the negative samples, wherein the 60 training driving data of the positive samples is collected from the target user A, while the 60 data of the negative samples could be collected from 60 training driving data combined by the non-target user B, the non-target user C or other non-target users at any ratio, namely, the positive and negative samples are mixed with the ratio of 1:1.

S14: training the training set with a bagging algorithm, and acquiring an original driving model.

The bagging algorithm is a method for improving the accuracy of a learning algorithm. In the bagging algorithm, a prediction function series is constructed in advance. The prediction function series includes at least two prediction functions. Then, the prediction function series is combined into a prediction function in a certain way. Specifically, the bagging algorithm refers to sampling the positive and negative samples from the training set for training in a sampling mode of repeated extractions and returns. The purpose of adopting the sampling mode of repeated extractions and returns is to increase quantities of the training samples, so that the training number of times of model is increased, thereby improving the accuracy rate. The original driving model is a model obtained by training and fusing the positive and negative samples in the training set using the bagging algorithm.

Ina specific implementation mode, as shown in FIG. 5, in step S14, the step of training the training set using the bagging algorithm and acquiring the original driving model specifically includes the following steps:

S141: inputting the positive and negative samples in the training set into at least two classification models for training, and acquiring a single driving model.

Each of the classification models is a model for solving classification problems, and each classification model is a prediction function in the bagging algorithm. Specifically, the classification models include, but not limited to, a logistic regression model, a neural network model, a decision tree model, a Naive Bayesian model and other models. The positive and negative samples in the training set are inputted into the at least two classification models for training to obtain at least two models for identifying a driver, i.e. single driving models. It could be understood that, each single driving model is associated with the user identifier, namely, each single driving model is a model for identifying the driving probability of the target user corresponding to the positive samples.

Preferably, the at least two classification models include a long short-term memory (hereinafter referred to as LSTM) model and a logistic regression (hereinafter referred to as LR) model.

The LSTM model is a time-recursive neural network model, and is suitable for processing and predicting important events having time sequences and relatively long time sequence intervals and delay. The LSTM model has a time memory function, and thus, is used for processing training business data that carry a time sequence status. The LSTM model is one of neural network models having a long-term memory capability, and has three layers of network structures, i.e., an input layer, a hidden layer and an output layer. Specifically, the LSTM model trains the training set by using a forward propagation algorithm, acquires an original single driving model, and then verifies the original single driving model by using a back propagation algorithm; and the single driving model is obtained through multiple iterations and verifications.

In step S141, the step of inputting the positive and negative samples in the training set into the at least two classification models for training and acquiring the single driving model specifically includes the following steps:

S141-11: training the positive and negative samples in the training set by adopting the forward propagation algorithm in the LSTM model, and acquiring the original single driving model. The computation formulas of the forward propagation algorithm include Sₜ=tan h(Uₓ_{ₜ}+Wₛ_{ₜ₋₁}) and ôₜ=soft max(Vₛ_{ₜ}), wherein Sₜ indicates an output of a hidden layer at a current moment; Uₓ_{ₜ} indicates a weight of the hidden layer from a previous moment to the current moment; Wₛ_{ₜ₋₁} indicates a weight from the input layer to the output layer; ôₜ indicates a predicted output of the current moment; and Vₛ_{ₜ} indicates a weight from the hidden layer to the output layer.

Specifically, the forward propagation algorithm refers to taking the input Xₜ of the current moment and the output Sₜ₋₁ of a hidden unit at the previous moment n (i.e., an output Sₜ₋₁ of a memory unit in the hidden layer in the ISTM model) as inputs of the hidden layer, and then converting an activation function tan h (a hyperbolic tangent function) to obtain an output Sₜ of the current moment in the hidden layer. Thus it can be seen that, the predicted output ôₜ is related to the output Sₜ of the current moment; and Sₜ includes an input of the current time and a status of the previous moment, so that the predicted output reserves all information on the time sequence, and has the time sequence. Due to insufficient expression capability of a linear model, the tan h (the hyperbolic tangent function) is taken as the activation function in the present embodiment, and a nonlinear factor could be added so that the trained original prediction model could solve more complicated problems. Moreover, the activation function tan h (the hyperbolic tangent function) has the advantage of high convergence speed, which could save the training time and increase the training efficiency.

S141-12: carrying out error calculation on the original single driving model by adopting the back propagation algorithm in the LSTM model, and acquiring the single driving model. The computation formula of the back propagation algorithm includes

$${E}_{t} = - {\sum }_{t} {o}_{t} log {\hat{o}}_{t} ,$$

wherein ôₜ indicates a predicted output of a moment t; and oₜ indicates a true value corresponding to ôₜ at the moment t. In the back propagation algorithm, the original signal driving model is subjected to the error calculation, and a weight parameter is updated and optimized according to a sequence of time reversal. In the present embodiment, the error calculation refers to calculating by defining a loss function of back propagation at the current moment as a cross entropy, and calculating an error with the above-mentioned error calculation formula. Finally, a partial derivative of each layer is calculated according to a chained derivation method, i.e.,

$$\frac{\partial E}{\partial W} , \frac{\partial E}{\partial V} and \frac{\partial E}{\partial U}$$

are calculated; and the three weight parameters (i.e., U, V and W) are updated based on the three change rates, to acquire the regulated state parameter.

$$\frac{\partial E}{\partial W} = {\sum }_{t} \frac{\partial {E}_{t}}{\partial W} , \frac{\partial E}{\partial V} = {\sum }_{t} \frac{\partial {E}_{t}}{\partial V} , and \frac{\partial E}{\partial U} = {\sum }_{t} \frac{\partial {E}_{t}}{\partial U} .$$

Thus, it can be seen that, it is only needed to calculate the partial derivative of the loss function at each moment and add all partial derivatives to obtain the above three change rates, thereby updating the weight parameter. Since a gradient increases exponentially with a progressive increase of number of back propagation layers and causes a phenomenon that the gradient disappears, a cross entropy loss function and the activation function tan h are cooperated to well solve the problem that the gradient disappears in the present embodiment, thereby increasing the accuracy rate of the training.

In step S141, the operation of inputting the positive and negative samples of the training set into the at least two classification models for training and acquiring the single driving model specifically includes the following steps:

S141-21: training the positive and negative samples in the training set using a logistic regression algorithm in the logistic regression model, and acquiring an original single driving model. The computation formulas of the logistic regression algorithm include

$${h}_{θ} ( x ) = \frac{1}{1 + {e}^{- {θ}^{m} x}} and J ( θ ) = - \frac{1}{m} [ {\sum }_{i = 1}^{n} {y}^{( i )} log ( {h}_{θ} ( {x}^{( i )} ) ) - ( 1 - {y}^{( i )} ) log ( 1 - {h}_{θ} ( {x}^{( i )} ) ) ] ,$$

wherein h_{θ}(x) indicates a probability density function of the positive and negative samples; x^{(j)} indicates an input of the positive and negative samples; y^{(t)} indicates an output result corresponding to the input of the positive and negative samples; and m indicates quantities of the positive and negative samples. The logistic regression (hereinafter referred to as LR) model, also called as a logistic regression analysis model, is one of classification and prediction algorithms, and could predict a probability of occurrence of a future result through performance of historical data.

In the present embodiment, the LR model is assumed to be h_{θ}(x)=g(θ^{m}x), wherein g(θ^{m}x) is a logic function, i.e., a probability that a datum belongs to a category (a binary classification problem). Specifically, a Sigmoid (a sigmoid growth curve) function is selected as the logic function. The Sigmoid function is a common Sigmoid function in biology; and in information science, due to monotone increasing of the Sigmoid function, monotone increasing of an inverse function and other properties, the Sigmoid function is usually used as a threshold function of the neural network and a variable is mapped between 0 and 1. A function formula of the Sigmoid function is

$$g ( z ) = \frac{1}{1 + {e}^{- z}} ,$$

wherein the above formula, i.e.,

$${h}_{θ} ( x ) = \frac{1}{1 + {e}^{- {θ}^{m} x}} ,$$

is obtained by substituting the Sigmoid function into a logistic regression hypothesis model; and further, a cost function of the LR model is

$$J ( θ ) = \frac{1}{m} {\sum }_{i = 1}^{m} Cost ( {h}_{θ} ( {x}^{i} ) , {y}^{( i )} ) .$$

The above formula, i.e.,

$$J ( θ ) = - \frac{1}{m} [ {\sum }_{{ }^{t = 1}}^{m} {y}^{( t )} log ( {h}_{θ} ( {x}^{( i )} ) ) - ( 1 - {y}^{( t )} ) log ( 1 - {h}_{θ} ( {x}^{( t )} ) ) ] ,$$

is obtained by substituting Cost(h_{θ}(x),y) into the cost function. Since the LR model is a binary classification model, assuming that the probability of a positive category is p, for an input, it could be obtained the input belongs to the positive category or a negative category by observing p/(1−p). The Sigmoid function could well reflect such characteristic of the LR model. Therefore, the LR model has high training efficiency.

S141-22: carrying out the error calculation on the original single driving model using a gradient descent algorithm in the LR model, and acquiring the single driving model. The computation formulas of the gradient descent algorithm include

$$\frac{\partial }{\partial {θ}_{j}} J ( θ ) = ( {h}_{θ} ( x ) - y ) {x}_{j} and {θ}_{j} = {θ}_{j} - \partial \frac{1}{m} {\sum }_{i = 1}^{m} ( {h}_{θ} ( {x}^{( i )} ) - {y}^{( i )} ) {x}_{j}^{( t )} ,$$

wherein θⱼ indicates θ value obtained by each iteration; h_{θ}(x) indicates a probability density function of the positive and negative samples; xⱼ indicates the positive and negative samples of the j-th iteration; J(θ) indicates the original single driving model; x⁽ⁱ⁾ indicates the positive and negative samples; and y⁽ⁱ⁾ indicates an output result. The gradient descent algorithm, also called as a steepest descent algorithm, refers to carrying out multiple iterations, derivations and optimization on the gradient to obtain the θ value when the cost function J(θ) has a minimum value, i.e., a required model parameter. Based on the model parameter, the single driving model is acquired. The gradient descent algorithm is simple in calculation and easy to realize.

S142: fusing at least two single driving models, and acquiring the original driving model.

Specifically, step S142 includes the following steps: firstly, acquiring a ratio of the positive samples to the negative samples in the test set, and determining a target probability. The target probability refers to a quotient value obtained by dividing quantities of the positive samples by the sum of quantities of the positive samples and quantities of the negative samples. Then, the positive and negative samples in the test set are inputted into the at least two single driving models for testing, and at least two classification probabilities are acquired. Then, the at least two classification probabilities are fused by adopting a fusion mechanism, and the original driving model is acquired. The original driving model includes the at least two classification probabilities and a weight corresponding to each single driving model.

Specifically, the step of fusing at least two single driving models includes a majority voting fusion way or a weighting fusion way.

The majority voting fusion way refers to taking a model parameter (i.e., a model parameter of the single driving model obtained through training in step S141) of the single driving model that the classification probability is closest to the target probability as the model parameter of the original driving model, to obtain the original driving model. The weighing fusion way refers to initializing a model weight corresponding to each single driving model in the original driving model in advance, multiplying the acquired at least two classification probabilities by the corresponding model weight, and summating, to obtain the final classification probability, so that the acquired classification probability is equal to or close to the target probability, and the final model weight is normalized and determined. Then, the model parameter (i.e., the model parameter of the single driving model obtained through training in step S141) corresponding to the at least two single driving models and the final model weight are taken as the model parameter and the model weight of the original driving model, to obtain the original driving model.

In step S142, the step of fusing at least two single driving models and acquiring the original driving model specifically includes the following steps:

S142-31: acquiring the target probability based on the ratio of the positive samples to the negative samples in the test set.

The positive samples and the negative samples in the test set are configured according to a preset ratio, and the target probability could be determined based on the ratio of the positive samples to the negative samples. The target probability refers to the quotient value obtained by dividing quantities of the positive samples by the sum of quantities of the positive and quantities of the negative samples.

S142-32: inputting the positive and negative samples of the test set into the at least two single driving models for testing, and acquiring the at least two classification probabilities. [0081] e positive and negative samples in the test set are inputted into the at least two classification models for testing, and the at least two classification probabilities are acquired. Namely, when fusing is conducted by adopting the majority voting fusion way, the positive and negative samples in the test set are inputted into the at least two single classification models, and the classification probability corresponding to each single driving model is acquired.

S142-33: selecting the single driving model corresponding to the classification probability which is closest to the target probability, and acquiring the original driving model.

In the present embodiment, the positive and negative samples in the test set are configured according to a ratio of 1:1, and when identifying is conducted based on the positive and negative samples in the test set, the probability of identifying that the target user drives is 50%, i.e., the target probability is 50%. The single driving model that the classification probability is closest to 50% (the target probability) is selected as the original driving model.

In step S142, the step of fusing at least two single driving models and acquiring the original driving model specifically includes the following steps:

S142-41: configuring the positive and negative samples in the test set according to different ratios, and acquiring at least two target probabilities.

Specifically, when fusing is conducted by adopting the weighing fusion way, the model weight of each single driving model could be initialized, and the positive and negative samples in the test set are configured according to the different ratios, to acquire a plurality of target probabilities.

S142-42: inputting the positive and negative samples in the test set into the at least two single driving models according to the different ratios for processing, and acquiring the classification probability corresponding to the single driving model.

Specifically, the positive and negative samples configured according to each ratio are inputted into the at least two single driving models for processing, and the corresponding classification probability is acquired.

S142-43: normalizing the model weight of each single driving model using a computational method P=ΣPₜWₜ, to determine the final model weight, wherein P indicates the target probability, Pᵢ indicates a test probability of the i-th single driving model; and Wᵢ indicates the model weight of the i-th single driving model.

According to P=ΣPₜWₜ, the model weight of each single driving model is normalized, to determine the final model weight. The computational method of the test probability is to determine a quotient value obtained by dividing the driving number of the target user by the sum of quantities of the positive samples and quantities of the negative samples (i.e., the sum of the driving quantity of the target user and the driving quantity of the non-target user) according to the acquired at least two classification probabilities.

S142-44: acquiring the original driving model based on the model parameter and the model weight of the at least two single driving models.

Specifically, any sample is inputted into the single driving model to identify and acquire the classification probability, and the classification probability is compared with the preset probability. If the classification probability is greater than the preset probability, the target user drives, and the driving quantity of the target user is added by 1, otherwise, the driving quantity of the non-target user is added by 1. Finally, the test probability is calculated and acquired based on the driving quantity of the target user and the driving quantity of the non-target user. The preset probability is a probability which is preset for evaluating whether the user drives.

Further, when the at least two single driving models are fused using the weighing fusion way, the single driving model having low accuracy rate of identification should be deleted in advance, to guarantee the accuracy rate of identification of the acquired original driving model. Specifically, the same positive and negative samples in the test set are inputted into the at least two single driving models, and the classification probability corresponding to each single driving model and the corresponding target probability are acquired. The corresponding probability range is determined based on the target probability and a preset coefficient, and whether each classification probability is within the probability range is judged. If the classification probability is within the probability range, it is considered that the accuracy rate of identification of the corresponding single driving model is relatively high, and the single driving model should be reserved. If the classification probability is beyond the probability range, it is considered that the accuracy rate of identification of the corresponding single driving model is relatively low, and the single driving model should be deleted. The preset coefficient is a coefficient pre-configured by the system. The probability range could be determined according to the preset coefficient and the target probability, and for example, could be set as 20%.

If the positive and negative samples configured according to 1:1 are simultaneously inputted into the at least two single driving models, the target probability thereof is 50%; and if the preset coefficient is 20%, the acquired probability range is (1−20%)×50%−(1+20%)×50%, i.e., 40%-60%. If the classification probability of any single driving model is within 40%-60%, it is considered that the accuracy rate of identification thereof is relatively high, and the single driving model could be reserved; and if the classification probability of any single driving model is beyond 40%-60%, it is considered that the accuracy rate of identification thereof is relatively low, and the single driving model should be deleted. The reserved at least two single driving models are fused by adopting the weighing fusion way, to acquire the original driving model, thereby guaranteeing the accuracy rate of identification of the acquired original driving model.

S15: testing the original driving model using the test set, and acquiring a target driving model.

All the positive and negative samples in the test set are inputted into the original driving model for testing, and the accuracy rate of an identification result is acquired. The accuracy rate of the identification result is a quotient by dividing the number of all accurate identification results by the number of all the positive and negative samples in the test set. It is judged whether the accuracy rate of the identification result is greater than a preset accuracy rate. If the accuracy rate of the identification result is greater than the preset accuracy rate, it is considered that the original prediction model is relatively accurate, so as to take the original prediction model as a target prediction model. Otherwise, if the accuracy rate of the identification result is not greater than the preset accuracy rate, it is considered that the original prediction result is inaccurate, and after steps S11-S14 are adopted for training, the training is conducted again until the accuracy rate of the identification result of the acquired original driving model is greater than the preset accuracy rate. In the present embodiment, the preset accuracy rate is a quotient value obtained by dividing quantities of the positive samples in the positive and negative samples in the test set by the sum of quantities of the positive samples and quantities of the negative samples.

In the driving model training method provided by the present embodiment, the training behavior data of the user is firstly acquired, and the training behavior data is associated with the user identifier, so as to respectively acquire the training behavior data corresponding to the target user identifier and the non-target user identifier based on the user identifier and guarantee that the target driving model obtained through training could identify the driving behavior of the target user. Then, the training driving data associated with the user identifier is acquired based on the training behavior data. The training driving data is training behavior data corresponding to the driving type extracted from different behavior types, thereby excluding interferences of other non-driving behavior data, contributing to guaranteeing the accuracy rate of identification of the target driving model obtained through training and improving the training efficiency of the target driving model, saving the training duration and providing the reliable and corresponding training driving data for the training process of the driving model, so as to achieve the training of the driving model. Next, the positive and negative samples are acquired from the training driving data based on the user identifier. The positive and negative samples could effectively determine the parameters required by a training target driving model, thereby guaranteeing the accuracy of the identification result of the target driving model obtained through training. Finally, the training set is trained using the bagging algorithm, and the original driving model is acquired and trained to acquire the target driving model, thereby enhancing the generalization of the target driving model, and improving the accuracy rate of identification of the target driving model. Specifically, when the target driving model is acquired using the bagging algorithm, the single driving models acquired by training the at least two classification models could be fused, to improve the generalization of the acquired target driving model.

It should be understood that, the size of the serial numbers of the steps in the above embodiments does not mean an execution sequence, and the execution sequence of each process shall be determined through a function and internal logic thereof, rather than forming any definition on the implementation process of embodiments of the present disclosure.

### Embodiment 2

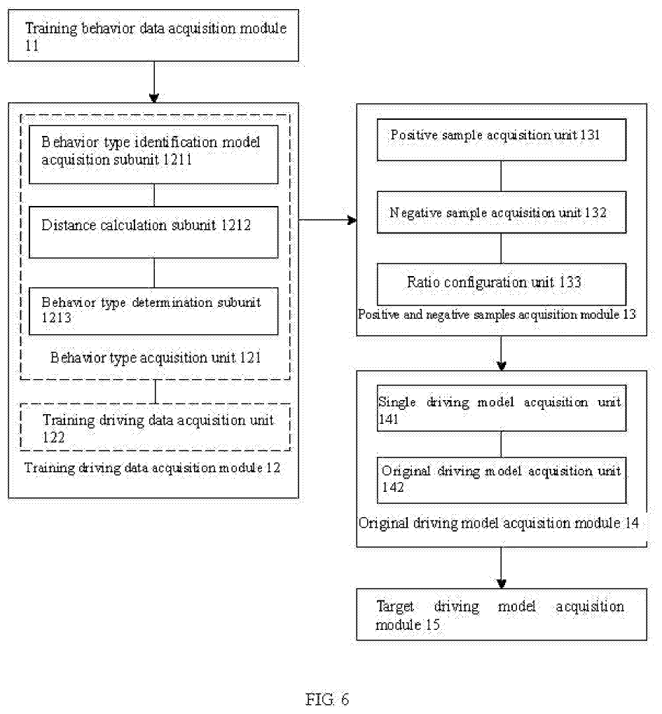

FIG. 6 is a principle block diagram of a driving model training apparatus in one-to-one correspondence with the driving model training method in Embodiment 1. As shown in FIG. 6, the driving model training apparatus comprises a training behavior data acquisition module 11, a training driving data acquisition module 12, a positive and negative samples acquisition module 13, an original driving model acquisition module 14 and a target driving model acquisition module 15. The implementation of the functions of the training behavior data acquisition module 11, the training driving data acquisition module 12, the positive and negative samples acquisition module 13, the original driving model acquisition module 14 and the target driving model acquisition module 15 is in one-to-one correspondence with the steps corresponding to the driving model training method in Embodiment 1. To avoid repeat, no detailed description is made in the present embodiment.

The training behavior data acquisition module 11 is configured to acquire training behavior data of a user, and the training behavior data is associated with a user identifier.

The training driving data acquisition module 12 is configured to acquire training driving data associated with the user identifier based on the training behavior data.

Preferably, the training driving data acquisition module 12 comprises a behavior type acquisition unit 121 and a training driving data acquisition unit 122.

The behavior type acquisition unit 121 is configured to acquire a behavior type corresponding to the training behavior data based on the training behavior data, and the behavior type is associated with the user identifier.

The training driving data acquisition unit 122 is configured to take the training behavior data that the behavior type is a driving type as the training driving data.

Preferably, the behavior type acquisition unit 121 comprises a behavior type identification model acquisition subunit 1211, a distance calculation subunit 1212, and a behavior type determination subunit 1213.

The behavior type identification model acquisition subunit 1211 is configured to acquire the trained behavior type identification model; the behavior type identification model comprises at least two clusters; and each of the clusters corresponds to a behavior type and comprises a centroid.

The distance calculation subunit 1212 is configured to calculate a distance from the training behavior data to each centroid.

The behavior type determination subunit 1213 is configured to take the behavior type corresponding to the cluster having a minimum distance as the behavior type corresponding to the training behavior data.

The positive and negative samples acquisition module 13 is configured to acquire positive and negative samples from the training driving data based on the user identifier, and divide the positive and negative samples into a training set and a test set.

Preferably, the positive and negative samples acquisition module 13 comprises a positive sample acquisition unit 131, a negative sample acquisition unit 132 and a ratio configuration unit 133.

The positive sample acquisition unit 131 is configured to select training driving data corresponding to a preset time period from the training driving data corresponding to the target user identifier as the positive sample.

The negative sample acquisition unit 132 is configured to select the training driving data corresponding to the same time period as the preset time period from the training driving data corresponding to a non-target user identifier as the negative sample.

The ratio configuration unit 133 is configured to configure quantities of the positive samples and the negative samples according to a preset ratio.

The original driving model acquisition module 14 is configured to train the training set using a bagging algorithm, and acquire an original driving model.

Preferably, the original driving model acquisition module 14 comprises a single driving model acquisition unit 141 and an original driving model acquisition unit 142.

The single driving model acquisition unit 141 is configured to input the positive and negative samples of the training set into the at least two classification models for training, and acquire a single driving model.

The original driving model acquisition unit 142 is configured to fuse the at least two single driving models, and acquire the original driving model.

The target driving model acquisition module 15 is configured to test the original driving model using the test set, and acquire a target driving model.

### Embodiment 3

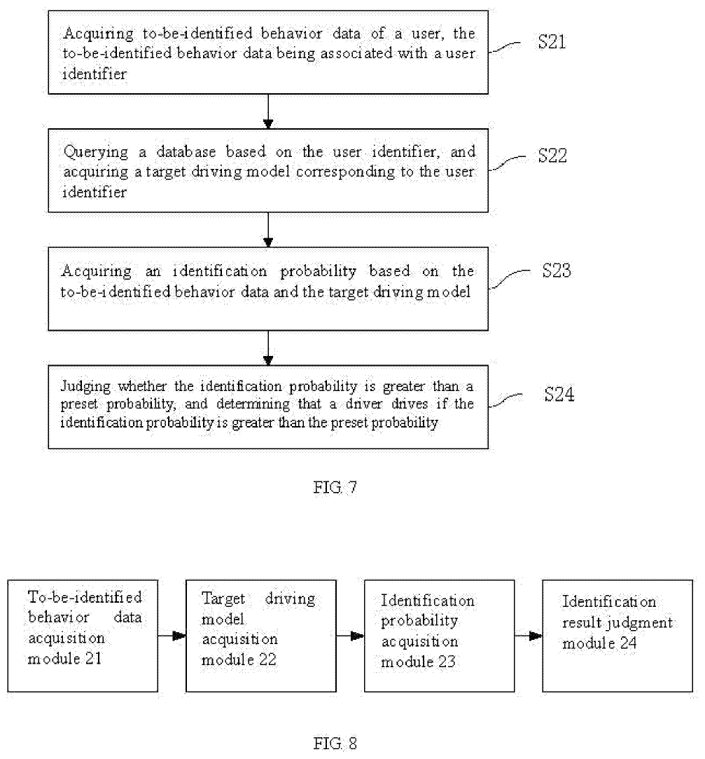

FIG. 7 is a flow chart of a driver identification method in the present embodiment. The driver identification method may be applied in a terminal device of an insurance institution or other institutions, so as to identify a driving behavior of a driver, thereby achieving an intelligent identification effect. As shown in FIG. 7, the driver identification method comprises the following steps:

S21: acquiring to-be-identified behavior data of a user, wherein the to-be-identified behavior data is associated with a user identifier.

The to-be-identified behavior data refers to behavior data collected by the user in real time when traveling and used for identifying whether the target user drives. The behavior data includes, but not limited to, at least one of a speed, an acceleration, an angle, an angular acceleration and other data collected by the user at any time when traveling. In the present embodiment, the to-be-identified behavior data is associated with the user identifier, which means that the to-be-identified behavior data formed by each user when traveling is associated with the user identifier, so as to find the corresponding target driving model based on the user identifier to identify the to-be-identified behavior data.

S22: querying a database based on the user identifier, and acquiring a target driving model corresponding to the user identifier, wherein the target driving model is a model acquired by the driving model training method in Embodiment 1.

In the present embodiment, the terminal device queries the target driving model stored in the database according to the user identifier in the to-be-identified behavior data, so as to identify based on the target driving model whether the to-be-identified behavior data is that the user corresponding to the user identifier drives. The target driving model and a model information table are stored in the database. The model information table comprises at least one piece of model information. Each of the model information includes the user identifier and a storage address of the target driving model corresponding to the user identifier in the database, so that the corresponding target driving model could be queried based on the user identifier when identifying is conducted through the target driving model. Specifically, the to-be-identified behavior data of the user A could be acquired for a mobile terminal of the user A in real time, and uploaded to a server, so that the terminal device in the insurance institution could acquire the to-be-identified behavior data from the server, query the storage address of the target driving model stored in the database and associated with the user identifier of the user A according to the user identifier about the user A in the to-be-identified behavior data, and acquire the corresponding target driving model based on the storage address.

S23: acquiring an identification probability based on the to-be-identified behavior data and the target driving model.

In the present embodiment, the to-be-identified behavior data is inputted to the target driving model for identifying, the to-be-identified behavior data inputted is subjected to conversion treatment based on weights among layers in the target driving model; and the identification probability is outputted at an output layer. Specifically, after the terminal device acquires the to-be-identified behavior data and the target driving model of the user A, the to-be-identified behavior data is subjected to the conversion treatment based on the weights among the layers in the target driving model; and the final identification probability is acquired. In the present embodiment, the identification probability could be a real number between 0 and 1.

S24: judging whether the identification probability is greater than a preset probability, and determining that a driver herself/himself drives if the identification probability is greater than the preset probability.

The preset probability is a probability which is preset for evaluating whether the user drives. In the present embodiment, the identification probability finally acquired by processing the to-be-identified behavior data in the target driving model is compared with the preset probability. If the identification probability is greater than the preset probability, it could be determined that a driver herself/himself drives. If the identification probability is less than or equal to the preset probability, it could be determined that the driver does not drive. Specifically, if the terminal device acquires that the identification probability of the user A is 0.95 and the preset probability is 0.9, it could be determined that the user A drives.

In the driver identification method provided by the present embodiment, the corresponding target driving model is queried and acquired based on the user identifier in the to-be-identified behavior data, and an acquisition process of the target driving model is simple and quick. Then, the to-be-identified behavior data is identified by using the target driving model, which is beneficial to guaranteeing the accuracy of the acquired identification probability. The identification probability outputted in the target driving model is compared with the preset probability and it is judged whether the identification probability is greater than the preset probability, to determine whether the driver herself/himself drives, i.e., to determine whether the user corresponding to the user identifier drives or the user corresponding to the user identifier takes saloon cars driven by other users, to guarantee that the identification result of the driver is more accurate and reliable.

### Embodiment 4

FIG. 8 is a principle block diagram of a driving model training apparatus in one-to-one correspondence with the driving model training method in Embodiment 1. As shown in FIG. 8, the driving model training apparatus comprises a to-be-identified behavior data acquisition module 21, a target driving model acquisition module 22, an identification probability acquisition module 23 and an identification result judgment module 24. The implementation of the functions of the to-be-identified behavior data acquisition module 21, the target driving data acquisition module 22, the identification probability acquisition module 23 and the identification result judgment module 24 is in one-to-one correspondence with the steps corresponding to the driving model training method in the embodiment. To avoid repeat, no detailed description is made in the present embodiment.

The to-be-identified behavior data acquisition module 21 is configured to acquire to-be-identified behavior data of a user, and the to-be-identified behavior data is associated with a user identifier.

The target driving model acquisition module 22 is configured to query a database based on the user identifier, and acquire a target driving model corresponding to the user identifier.

The identification probability acquisition module 23 is configured to acquire an identification probability based on the to-be-identified behavior data and the target driving model.

The identification result judgment module 24 is configured to judge whether the identification probability is greater than a preset probability, and determine that a driver herself/himself drives if the identification probability is greater than the preset probability.

In the driver identification method provided in the present embodiment, the to-be-identified behavior data acquisition module 21 achieves a collection function of the to-be-identified behavior data sent by the user in real time, thereby providing a data basis of model identification for the driver identification. The target driving model acquisition module 22 queries and acquires the corresponding target driving model based on the user identifier in the to-be-identified behavior data, and an acquisition process of the target driving model is simple and quick. The to-be-identified behavior data is inputted into the driving model for identification treatment through the identification probability acquisition module 23 and the identification result judgment module 24, and the to-be-identified behavior data is identified by virtue of the target driving model, which is beneficial to guaranteeing the accuracy of the acquired identification probability. By comparing the identification probability outputted by the target driving model with the preset probability, the effective identification could be achieved for a driver represented by the to-be-identified behavior data, to guarantee that the driver identification result is more accurate and reliable.

### Embodiment 5

The present embodiment provides a computer readable storage medium which stores a computer readable instruction. When the computer readable instruction is executed by a processor, the driving model training method in Embodiment 1 is achieved. To avoid repeat, no detailed description is made in the present embodiment. Or, when the computer readable instruction is executed by the processor, the functions of modules/units in the driving model training apparatus in Embodiment 2 are achieved. To avoid repeat, no detailed description is made in the present embodiment. Or, when the computer readable instruction is executed by the processor, the functions of the steps in the driver identification method in Embodiment 3 are achieved. To avoid repeat, no detailed description is made in the present embodiment. Or, when the computer readable instruction is executed by the processor, the functions of modules/units in the driver identification apparatus in Embodiment 4 are achieved. To avoid repeat, no detailed description is made in the present embodiment.

### Embodiment 6

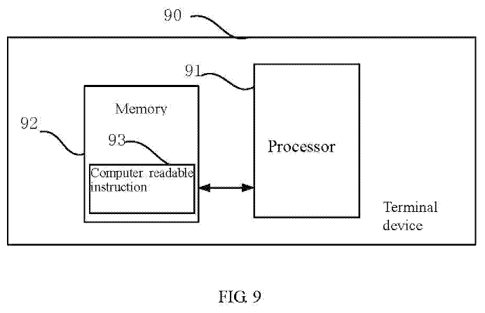

FIG. 9 is a schematic diagram of a terminal device provided in one embodiment of the present disclosure. As shown in FIG. 9, the terminal device 90 of the embodiment comprises: a processor 91, a memory 92 and a computer readable instruction 93 stored in the memory 92 and operated on the processor 91. When the computer readable instruction is executed by the processor 91, the driving model training method in Embodiment 1 is achieved. To avoid repeat, no detailed description is made in the present embodiment. Or, when the computer readable instruction is executed by the processor 91, the functions of the modules/units in the driving model training apparatus in Embodiment 2 are achieved. To avoid repeat, no detailed description is made in the present embodiment. Or, when the computer readable instruction is executed by the processor 91, the functions of the steps in the driver identification method in Embodiment 3 are achieved. To avoid repeat, no detailed description is made in the present embodiment. Or, when the computer readable instruction is executed by the processor 91, the functions of the modules/units in the driver identification apparatus in Embodiment 4 are achieved. To avoid repeat, no detailed description is made in the present embodiment.

Exemplarily, the computer readable instruction 93 could be divided into one or more modules/units which are stored in the memory 92 and executed by the processor 91, to complete the present disclosure. The one or more modules/units could be a series of computer readable instruction segments capable of completing a specific function. The instruction segments are used for describing an execution process of the computer readable instruction 93 in the terminal device 90. For example, the computer readable instruction 93 could be divided into the training behavior data acquisition module 11, the training driving data acquisition module 12, the positive and negative samples acquisition module 13, the original driving model acquisition module 14 and the target driving model acquisition module 15 in Embodiment 2, or the computer readable instruction 93 could be divided into the to-be-identified behavior data acquisition module 21, the target driving model acquisition module 22, the identification probability acquisition module 23 and the identification result judgment module 24 in Embodiment 4. The specific functions of the modules are described in Embodiment 2 or Embodiment 4, and will not be repeated one by one herein.

The terminal device 90 may be a desktop computer, a notebook computer, a palm computer, a cloud server and other computer devices. The terminal device may include, but not limited to, the processor 91 and the memory 92. Those skilled in the art could understand that, FIG. 9 is only an example of the terminal device 90, does not form the limitation to the terminal device 90, may include components more or less than the components shown in the figure, or may combine some components or different components. For example, the terminal device may further include input and output devices, a network access device, a bus, etc.

The processor 91 may be a central processing unit (CPU), and may also be other universal processors, a digital signal processor (DSP), an application specific integrated circuit (ASIC), a field-programmable gate array (FPGA) or other programmable logic devices, a discrete or transistor logic device, a discrete hardware component, etc. The universal processor may be a microprocessor or the processor may also be called as any conventional processor, etc.

The memory 92 may be an internal storage unit of the terminal device 90, such as a hard disk or an internal memory of the terminal device 90. The memory 92 may also be an external storage device of the terminal device 90, such as a plug-in type hard disk arranged on the terminal device 90, a smart media card (SMC), a secure digital (SD) card, a flash card, etc. Further, the memory 92 could also include an internal storage unit of the terminal device 90, and could also include an external storage device. The memory 92 is used for storing the computer readable instruction and other programs and data required by the terminal device. The memory 92 could also be used for temporarily storing data that has been outputted or will be outputted.

Those skilled in the art could clearly understand that, for convenient and concise description, the illustration is only made through the division of the functional units and modules. In actual application, the above functions could be distributed and completed by different functional units and modules according to needs, i.e., an internal structure of the apparatus is divided into different functional units or modules, to complete all or part of functions described above.

In addition, the functional units in the embodiments of the present disclosure could be integrated into one processing unit; each unit could also exist separately and physically; and two or more than two units can also be integrated into one unit. The above integrated units could be achieved in a hardware form, and could also be achieved in a form of a software function unit.

If the integrated modules/units are achieved in the form of the software functional unit and sold or used as an independent product, the integrated modules/units could be stored in one computer readable storage medium. Based on such understanding, the present disclosure achieves all or part of processes in the method of the embodiments, and could also instruct relevant hardware through the computer readable instruction to complete. The computer readable instruction could be stored in a computer readable storage medium. When the computer readable instruction is executed by the processor, the steps of each method embodiment could be achieved. The computer readable instruction includes a computer readable instruction code which could be a source code form, an object code form, an executable file or some intermediate forms, etc. The computer readable medium could include: any entity or apparatus capable of carrying the computer readable instruction code, a recording medium, a U flash disk, a mobile hard disk, a diskette, an optical disk, a computer memory, a read-only memory (ROM), a random access memory (RAM), an electric carrier signal, a telecommunication signal, a software distribution medium, etc. It should be noted that, the content included in the computer readable medium could be appropriately increased and decreased according to requirements of legislation and patent practice under judicial jurisdictions. For example, in some judicial jurisdictions, the computer readable medium does not include the electric carrier signal and the telecommunication signal according to the legislation and the patent practice.

The above embodiments are only illustrative for the technical solutions of the present disclosure, rather than limiting the present disclosure. Although the present disclosure is described in detail with reference to the above embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

1. A driving model training method, comprising:
acquiring training behavior data of a user wherein the training behavior data are associated with a user identifier;
acquiring training driving data associated with the user identifier based on the training behavior data;
acquiring positive and negative samples from the training driving data based on the user identifier, and dividing the positive and negative samples into a training set and a test set;
training the training set using a bagging algorithm, and acquiring an original driving model; and
testing the original driving model using the test set, and acquiring a target driving model.

2. The driving model training method according to claim 1, wherein the step of acquiring the training driving data associated with the user identifier based on the training behavior data comprises:
acquiring a behavior type corresponding to the training behavior data based on the training behavior data wherein the behavior type is associated with the user identifier; and
taking the training behavior data that the behavior type is the driving type as the training driving data.

3. The driving model training method according to claim 2, wherein the step of acquiring the behavior type associated with the user identifier based on the training behavior data comprises:
acquiring the trained behavior type identification model which comprises at least two clusters with each corresponding to a behavior type and comprising a centroid;
calculating a distance from the training behavior data to each centroid; and
taking a behavior type corresponding to the cluster having a minimum distance as the behavior type corresponding to the training behavior data.

4. The driving model training method according to claim 1, wherein the step of training the training set using the bagging algorithm and acquiring the original driving model comprises:
inputting the positive and negative samples of the training set into at least two classification models for training, and acquiring a single driving model; and
fusing at least two single driving models, and acquiring the original driving model.

5. The driving model training method according to claim 4, wherein the classification models comprise a long short-term memory model;
the step of inputting the positive and negative samples in the training set into the at least two classification models for training and acquiring the single driving model comprises:
training the positive and negative samples in the training set by adopting a forward propagation algorithm in the long short-term memory model, and acquiring the original single driving model, wherein the computation formulas of the forward propagation algorithm comprise Sₜ=tan h(Uₓ_{ₜ}+Wₛ_{ₜ₋₁}) and ôₜ=soft max(Vₛ_{ₜ}), wherein Sₜ indicates an output of a hidden layer at a current moment; Uₓ_{ₜ} indicates a weight of the hidden layer from a previous moment to the current moment; Wₛ_{ₜ₋₁} indicates a weight from the input layer to the output layer; ôₜ indicates a predicted output of the current moment; and Vₛ_{ₜ} indicates a weight from the hidden layer to the output layer; and
carrying out error calculation on the original single driving model by adopting a back propagation algorithm in the long short-term memory model, and acquiring the single driving model, wherein the computation formula of the back propagation algorithm comprises
$${E}_{t} = - {\sum }_{t} {o}_{t} log {\hat{o}}_{t} ,$$
wherein ôₜ indicates a predicted output of a moment t; and oₜ indicates a true value corresponding to ôₜ at the moment t.

6. The driving model training method according to claim 4, wherein the classification models comprise a logistic regression model;
the step of inputting the positive and negative samples of the training set into the at least two classification models for training and acquiring the single driving model comprises:
training the positive and negative samples in the training set using a logistic regression algorithm in the logistic regression model, and acquiring an original single driving model, wherein the computation formulas of the logistic regression algorithm comprise
$${h}_{θ} ( x ) = \frac{1}{1 + {e}^{- {θ}^{m} x}} and J ( θ ) = - \frac{1}{m} [ {\sum }_{i = 1}^{m} {y}^{( i )} log ( {h}_{θ} ( {x}^{( i )} ) ) - ( 1 - {y}^{( i )} ) log ( 1 - {h}_{θ} ( {x}^{( i )} ) ) ] ,$$
wherein h_{θ}(x) indicates a probability density function of the positive and negative samples; x⁽ⁱ⁾ indicates an input of the positive and negative samples; y^{(t)} indicates an output result corresponding to the input of the positive and negative samples; and m indicates quantities of the positive and negative samples; and
carrying out the error calculation on the original single driving model using a gradient descent algorithm in the logistic regression model, and acquiring the single driving model, wherein the computation formulas of the gradient descent algorithm comprise
$$\frac{\partial }{\partial {θ}_{j}} J ( θ ) = ( {h}_{θ} ( x ) - y ) {x}_{j} and {θ}_{j} = {θ}_{j} - \partial \frac{1}{m} {\sum }_{i = 1}^{m} ( {h}_{θ} ( {x}^{( i )} ) - {y}^{( i )} ) {x}_{j}^{( i )} ,$$
wherein θⱼ indicates θ value obtained by each iteration; h_{θ}(x) indicates a probability density function of the positive and negative samples; xⱼ indicates the positive and negative samples of the j-th iteration; and J(θ) indicates the original single driving model.

7. The driving model training method according to claim 4, wherein the step of fusing at least two single driving models comprises a majority voting fusion way;
the step of fusing at least two single driving models and acquiring the original driving model comprises:
acquiring the target probability based on the ratio of the positive samples to the negative samples in the test set;
inputting the positive and negative samples of the test set into the at least two single driving models for testing, and acquiring the at least two classification probabilities; and
selecting the single driving model corresponding to the classification probability which is closest to the target probability, and acquiring the original driving model.

8. The driving model training method according to claim 4, wherein the step of fusing at least two single driving models comprises a weighting fusion way;
the step of fusing at least two single driving models and acquiring the original driving model comprises:
configuring the positive and negative samples in the test set according to different ratios, and acquiring at least two target probabilities;
inputting the positive and negative samples in the test set into the at least two single driving models according to the different ratios for processing, and acquiring the classification probability corresponding to the single driving model;
normalizing the model weight of each single driving model using a computational method P=ΣPₜWₜ, to determine the final model weight, wherein P indicates the target probability, Pₜ indicates a test probability of the i-th single driving model; and Wₜ indicates the model weight of the i-th single driving model; and
acquiring the original driving model based on the model parameter and the model weight of the at least two single driving models.

9. The driving model training method according to claim 1, wherein the step of acquiring the positive and negative samples from the training driving data based on the user identifier comprises:
selecting the training driving data corresponding to the preset time period from the training driving data corresponding to the target user identifier as the positive sample;
selecting the training driving data corresponding to the same time period as the preset time period from the training driving data corresponding to a non-target user identifier as the negative sample; and
configuring quantities of the positive samples and the negative samples according to a preset ratio.

10-12. (canceled)

13. A terminal device, comprising a memory, a processor and a computer readable instruction stored in the memory and operated on the processor, wherein the following steps are achieved when the processor executes the computer readable instruction:
acquiring training behavior data of a user wherein the training behavior data are associated with a user identifier;
acquiring training driving data associated with the user identifier based on the training behavior data;
acquiring positive and negative samples from the training driving data based on the user identifier, and dividing the positive and negative samples into a training set and a test set;
training the training set using a bagging algorithm, and acquiring an original driving model; and
testing the original driving model using the test set, and acquiring a target driving model.

14. The terminal device according to claim 13, wherein the step of acquiring the training driving data associated with the user identifier based on the training behavior data comprises:
acquiring a behavior type corresponding to the training behavior data based on the training behavior data wherein the behavior type is associated with the user identifier; and
taking the training behavior data that the behavior type is the driving type as the training driving data.

15. The terminal device according to claim 14, wherein the step of acquiring a behavior type associated with the user identifier based on the training behavior data comprises:
acquiring the trained behavior type identification model which comprises at least two clusters with each corresponding to a behavior type and comprising a centroid;
calculating a distance from the training behavior data to each centroid; and
taking a behavior type corresponding to the cluster having a minimum distance as the behavior type corresponding to the training behavior data.

16. The terminal device according to claim 13, wherein the step of training the training set using a bagging algorithm and acquiring an original driving model comprises:
inputting the positive and negative samples in the training set into at least two classification models for training, and acquiring a single driving model; and
fusing at least two single driving models, and acquiring the original driving model.

17. The terminal device according to claim 16, wherein the classification models comprise a long short-term memory model;
the step of inputting the positive and negative samples in the training set into the at least two classification models for training and acquiring the single driving model comprises:
training the positive and negative samples in the training set by adopting a forward propagation algorithm in the long short-term memory model, and acquiring the original single driving model, wherein the computation formulas of the forward propagation algorithm comprise Sₜ=tan h(Uₓ_{ₜ}+Wₛ_{ₜ₋₁}) and ôₜ=soft max(Vₛ_{ₜ}), wherein Sₜ indicates an output of a hidden layer at a current moment; Uₓ_{ₜ} indicates a weight of the hidden layer from a previous moment to the current moment; Wₛ_{ₜ₋₁} indicates a weight from the input layer to the output layer; ôₜ indicates a predicted output of the current moment; and Vₛ_{ₜ} indicates a weight from the hidden layer to the output layer; and
carrying out error calculation on the original single driving model by adopting a back propagation algorithm in the long short-term memory model, and acquiring the single driving model, wherein the computation formula of the back propagation algorithm comprises
$${E}_{t} = - {\sum }_{t} {o}_{t} log {\hat{o}}_{t} ,$$
wherein oₜ indicates a predicted output of a moment t; and oₜ indicates a true value corresponding to ôₜ at the moment t.

18. The terminal device according to claim 16, wherein the classification models comprise a logistic regression model;
the step of inputting the positive and negative samples of the training set into the at least two classification models for training and acquiring the single driving model comprises:
training the positive and negative samples in the training set using a logistic regression algorithm in the logistic regression model, and acquiring an original single driving model, wherein the computation formulas of the logistic regression algorithm comprise
$${h}_{θ} ( x ) = \frac{1}{1 + {e}^{- {θ}^{m} x}} and J ( θ ) = - \frac{1}{m} [ {\sum }_{i = 1}^{m} {y}^{( i )} log ( {h}_{θ} ( {x}^{( i )} ) ) - ( 1 - {y}^{( i )} ) log ( 1 - {h}_{θ} ( {x}^{( i )} ) ) ] ,$$
wherein h_{θ}(x) indicates a probability density function of the positive and negative samples; x⁽ⁱ⁾ indicates an input of the positive and negative samples; y^{(t)} indicates an output result corresponding to the input of the positive and negative samples; and m indicates quantities of the positive and negative samples; and
carrying out the error calculation on the original single driving model using a gradient descent algorithm in the logistic regression model, and acquiring the single driving model, wherein the computation formulas of the gradient descent algorithm comprise
$$\frac{\partial }{\partial {θ}_{j}} J ( θ ) = ( {h}_{θ} ( x ) - y ) {x}_{j} and {θ}_{j} = {θ}_{j} - \partial \frac{1}{m} {\sum }_{i = 1}^{m} ( {h}_{θ} ( {x}^{( i )} ) - {y}^{( i )} ) {x}_{j}^{( i )} ,$$
wherein θⱼ indicates θ value obtained by each iteration; h_{θ}(x) indicates a probability density function of the positive and negative samples; xⱼ indicates the positive and negative samples of the j-th iteration; and J(θ) indicates the original single driving model.

19. The terminal device according to claim 16, wherein the step of fusing at least two single driving models comprises a majority voting fusion way;
the step of fusing at least two single driving models and acquiring the original driving model comprises:
acquiring the ratio of the positive samples to the negative samples in the test set;
acquiring the target probability based on the ratio of the positive samples to the negative samples in the test set;
inputting the positive and negative samples of the test set into the at least two single driving models for testing, and acquiring the at least two classification probabilities; and
selecting the single driving model corresponding to the classification probability which is closest to the target probability, and acquiring the original driving model.

20. The terminal device according to claim 16, wherein the step of fusing at least two single driving models comprises a weighting fusion way,
the step of fusing at least two single driving models and acquiring the original driving model comprises:
configuring the positive and negative samples in the test set according to different ratios, and acquiring at least two target probabilities;
inputting the positive and negative samples in the test set into the at least two single driving models according to the different ratios for processing, and acquiring the classification probability corresponding to the single driving model;
normalizing the model weight of each single driving model using a computational method P=ΣPₜWₜ, to determine the final model weight, wherein P indicates the target probability, Pₜ indicates a test probability of the i-th single driving model; and Wₜ indicates the model weight of the i-th single driving model; and
acquiring the original driving model based on the model parameter and the model weight of the at least two single driving models.

21. The terminal device according to claim 13, wherein the step of acquiring the positive and negative samples from the training driving data based on the user identifier comprises:
selecting the training driving data corresponding to a preset time period from the training driving data corresponding to the target user identifier as the positive sample;
selecting the training driving data corresponding to the same time period as the preset time period from the training driving data corresponding to a non-target user identifier as the negative sample; and
configuring quantities of the positive samples and the negative samples according to a preset ratio.

22. (canceled)

23. A computer readable storage medium, storing the compute readable instruction, wherein the following steps are achieved when the computer readable instruction is executed by a processor:
acquiring training behavior data of a user wherein the training behavior data are associated with a user identifier;
acquiring training driving data associated with the user identifier based on the training behavior data;
acquiring positive and negative samples from the training driving data based on the user identifier, and dividing the positive and negative samples into a training set and a test set;
training the training set using a bagging algorithm, and acquiring an original driving model; and
testing the original driving model using the test set, and acquiring a target driving model.

24. The computer readable storage medium according to claim 23, wherein the step of acquiring the training driving data associated with the user identifier based on the training behavior data comprises:
acquiring a behavior type corresponding to the training behavior data based on the training behavior data wherein the behavior type is associated with the user identifier; and
taking the training behavior data that the behavior type is the driving type as the training driving data.

25-31. (canceled)
